(19) United States
(12) Patent Application Publication
(10) Pub. No.: US 2009/0203283 A1
(43) Pub. Date: Aug. 13, 2009

(54) Method for sealing an electronic device

(76) Inventor: Margaret Helen Gentile, Painted Post, NY (US)

Correspondence Address: CORNING INCORPORATED, SP-TI-3-1, CORNING, NY, 14831, US

(21) Appl. No.: 12/069,133

(22) Filed: Feb. 7, 2008

(51) Int. Cl. H01J 9/00

(52) U.S. Cl. 445/25

(57) ABSTRACT

A method for sealing an electronic device, such as an OLED display device or a photovoltaic device. An assembly comprising first and second substantially planar substrates with an electronic component disposed therebetween and encircled by a sealing material such as a glass frit is placed on a support plate. A pressure plate is positioned over the assembly. Electromagnets disposed in the support plate are activated by flowing a current through the electromagnets, and the magnetic force developed by the electromagnets draws the pressure plate toward the support plate, thereby applying a force against the assembly. The sealing material (e.g. glass frit) may be irradiated by an irradiation source, such as a laser, thereby forming a hermetic seal between the first and second substrates.

### BACKGROUND OF THE INVENTION

1. Field of the Invention

The present invention relates generally to a method of sealing an electronic device, and particularly to a method for sealing an organic light emitting diode (OLED) display device.

### TECHNICAL BACKGROUND

Organic light emitting diode displays hold great promise. They can be made thinner and lighter than liquid crystal or plasma displays, with brighter colors, higher contrast ratios, and lower power requirements. However, OLED displays are acutely sensitive to oxygen and moisture that can degrade the organic materials that comprise the display and hence its performance. Adhesives, such as an epoxy, do not form seals between the display substrates with sufficient hermiticity to yield display lifetimes that can compete with more established LCD and plasma displays, particularly for large size applications such as televisions.

One promising approach to longer life OLED displays is to employ a glass frit seal between the display substrates. By using a glass frit as the sealing material between the several glass substrates comprising the display, a true hermetic package can be produced. Nevertheless, to ensure proper sealing, the frit must have sufficient contact with the substrates. A force applied to at least one of the substrates during the sealing process can provide for good contact between the frit and the substrates, but the application of such a force must be clean, non-contaminating, and not impede the sealing process.

### SUMMARY

In one embodiment of the present invention, a method of sealing an organic light emitting diode (OLED) display device is disclosed providing an assembly comprising first and second glass substrates in an opposed relationship, a flit positioned between the first or second substrates, and an organic light emitting layer positioned between the first and second substrates and encircled by the frit, positioning the assembly on a support plate, the support plate comprising a plurality of electromagnets, positioning a ferrous plate over the assembly, flowing a current through the plurality of electromagnets, thereby causing the ferrous plate to apply a force against the assembly, and irradiating the frit with an irradiation source to heat and soften the frit and produce a hermetic seal between the first and second glass substrates to form the OLED display device.

In another embodiment, a method of sealing an electronic device is described comprising providing an assembly comprising first and second glass substrates in an opposed relationship, a frit disposed on one of the first or second substrates, and an electrically active layer encircled by the frit positioned between the first and second glass substrates, positioning the assembly on a support plate comprising an array of electromagnets, positioning a plate comprising a magnetic material over the assembly, flowing a current through the plurality of electromagnets thereby causing the plate comprising the magnetic material to apply a force against the assembly, irradiating the frit with a laser to heat and soften the frit and form a hermetic seal between the first and second glass substrates to form the electronic device.

It should be noted that although the following discussion is directed to the sealing of organic light emitting diode (OLED) displays, the present invention may be employed in other applications where the formation of a hermetic seal between two suitable substrates is needed, and in particular the sealing of glass plates with frit to form a hermetically sealed glass package. For example, the present invention may be used in the sealing of photovoltaic devices, surface emission displays (SEDs), field emission displays (FEDs) and OLED lighting panels to name a few.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 is a cross sectional view of an OLED display device.

FIG. 2 is a cross sectional view of a sealing apparatus according to an embodiment of the present invention utilizing electromagnets disposed in a support plate.

FIG. 3 is a top view of a display assembly according to embodiments of the present invention, with a pressure plate disposed thereon.

FIG. 4 is a perspective view of a support plate according to an embodiment of the present invention.

FIG. 5 is a cross sectional view of a support plate according to an embodiment of the present invention wherein a surface of the support plate is covered with a covering plate, which is interposed between the display assembly and the support plate.

FIG. 6 is a cross sectional view of support plate according to an embodiment of the present invention comprising bore which do not extend through an entire thickness of the support plate, leaving a smooth surface on which the display assembly can rest.

FIG. 7 is a perspective view, shown in partial cutaway, of a pressure plate having multiple apertures overtop a display assembly supported by the support plate of FIG. 4

FIG. 8 is a cross sectional view of another embodiment of a support plate according to the present invention wherein the support plate is porous and a vacuum is drawn on one side of the plate to assist in retaining a display assembly thereon.

FIG. 9 is a cross sectional view of a sealing apparatus according to an embodiment of the present invention utilizing electromagnets disposed in a support plate and having a mask interposed between the support plate and the pressure plate.

### DETAILED DESCRIPTION

Reference will now be made in detail to embodiments of the invention, examples of which are illustrated in the accompanying drawings. Whenever possible, the same reference numerals will be used throughout the drawings to refer to the same or like parts.

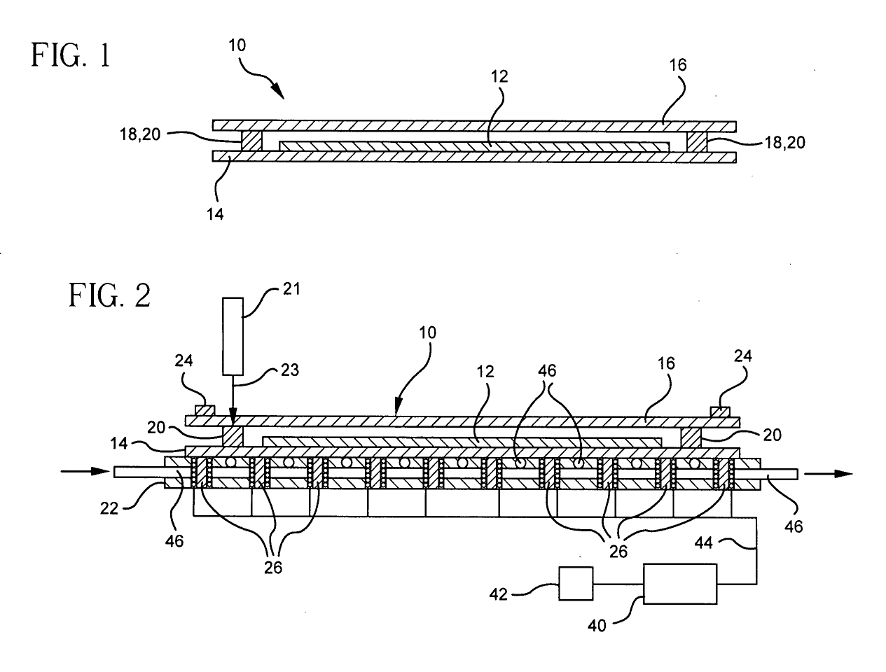

As shown in FIG. 1, an organic light emitting diode (OLED) display 10 typically comprises at least one organic light emitting diode device 12 sandwiched between two substantially planar substrates 14 and 16, a hermetic seal 18 being formed between the two substrates. Organic light emitting diode device 12 is positioned between substrates 14, 16, typically by depositing on substrate 14, and comprises one or more organic layers, and electrode layers (e.g. anode and cathode), not individually shown in FIG. 1. Electrical leads (not shown) in contact with the electrode layers traverse the hermetic seal and connect OLED device 12 to controllers and other electrical/electronic devices and equipment suitable for operating the OLED display. For example, the OLED device 12 may include thin film transistor (TFT) circuitry, also disposed on substrate 14, to drive the device. The controllers may be included on a surface of one of the substrates, or may be unattached to either of the substrates.

To utilize economies of scale, display manufacturers may form multiple displays within the boundaries of the two substrates 14, 16, only separating the individual displays from the parent glass substrates once the individual displays have been hermetically sealed. As used herein, “OLED” or “OLED device” is to be construed as the one or more organic light emitting diodes comprising a display. “Display” or “display device” refers to a collection of one or more OLED devices that are arranged between suitable substrates to form a graphic element that can be used in such applications as televisions, cell phones, computers, etc. Generally, the term display or display device shall be used to denote this graphic element in both an assembled but unsealed condition, or in a sealed condition. If an unsealed display is specifically intended, the term “display assembly” will be used.

In a typical manufacturing process, one or more OLED devices are formed on first substrate 14. A closed wall is formed on second substrate 16 with sealing material 20. In some instances this sealing material can be an adhesive such as an epoxy. In preferred embodiments, sealing material 20 is a glass frit that is dispensed onto the second substrate as a wall in a closed pattern resembling a loop or picture frame that, when the second substrate is positioned opposite the first substrate such that the frit wall is positioned between the first and second substrates, the one or more OLED devices are located within the encircling frit wall.

After the frit wall has been dispensed, second substrate 16 is heated to volatilize binders and vehicles comprising the frit paste, and to pre-sinter the frit and adhere it to the second substrate. Second substrate 16 may be heated, for example, in a suitable furnace. The first and second substrates are then brought together such that the pre-sintered frit wall is between and separates the first and second substrates. The frit is then heated until the frit softens, and then cools, to form hermetic seal 18 between the first and second substrates. In embodiments where an environmentally sensitive component (e.g. sensitive to temperature, environmental gasses, etc.), such as an OLED device, is hermetically sealed between the first and second substrates, it is desirable that the heating of frit 20 to form seal 18 is localized to the frit. Localized heating can be performed, for example, by employing a source of electromagnetic radiation. For example, a laser can be used to direct a laser beam onto the frit. Alternatively, a broadband source, such as an infrared lamp, can be used. Typically, the use of a lamp is coupled with a mask to avoid heating areas of the assembly adjacent the frit.

In a laser sealing procedure, the frit and the laser may be selected such that the frit is highly absorbing at the wavelength, or range of wavelengths of light emitted by laser 21. For example, the frit composition may be such that the frit is highly absorbing in the infrared wavelength region, in which case a laser should be chosen that emits a light in the infrared wavelength region. On the other hand, it is desirable that the first and/or second substrates 14, 16 through which the emitted laser light passes on its way to the frit are substantially transparent to the laser light 23.

It should be understood that the present invention is not limited to the manufacture of OLED display devices, but may be satisfactorily used on a wide variety of devices that may benefit from a method capable of forming a hermetic seal between two substrates. Embodiments of the present invention may be used to seal other photonic or electronic devices. For example, although the remainder of the present description will be directed to OLED display devices, embodiments of the present invention may be used to seal photovoltaic devices. Moreover, it should be further understood that although an exemplary laser and frit sealing process is described herein, other sealing processes (e.g. radiation-cured epoxy) may also benefit from advantages of the present invention.

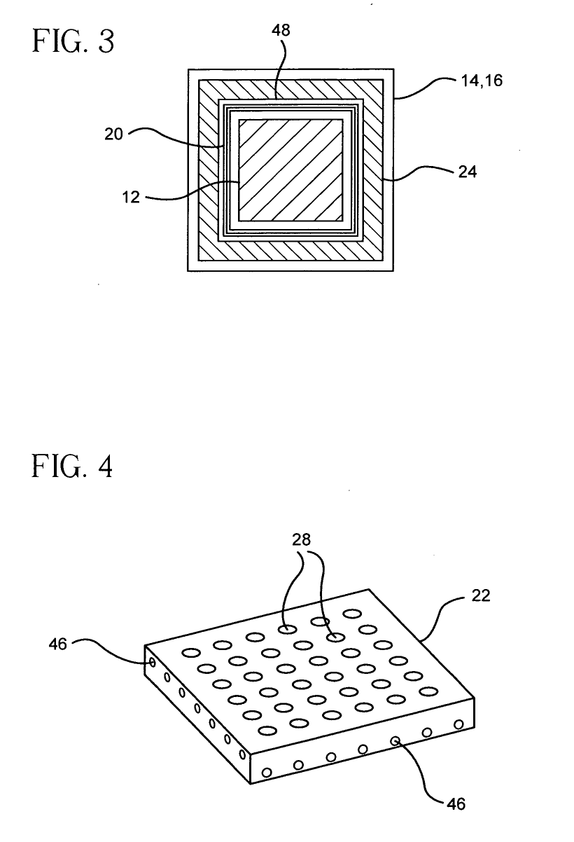

In accordance with one embodiment of the present invention, an OLED display assembly 10 is shown in FIG. 2 comprising first glass substrate 14 positioned opposite second glass substrate 16. By “assembly” what is meant is an unsealed OLED display. Sealing material 20 and one or more OLED devices 12 are positioned between first and second glass substrates 14, 16. As can best be seen in FIG. 3, sealing material 20 (in this instance, glass frit 20) encircles OLED device 12. Glass frit 20 may be presintered, or not, depending on the particular sealing process employed.

Continuing with reference to FIGS. 2-3, OLED display assembly 10 is positioned over support plate 22, and pressure plate 24 is positioned over assembly 10, thereby sandwiching display assembly 10 between support plate 22 and pressure plate 24. A plurality of electromagnets 26 are disposed within the support plate and preferably laid out in an ordered arrangement. For example, a rectangular grid of electromagnets disposed in support plate 22 is well-suited to forming a display device. However, other arrangements are possible, such as a circular grid comprising circular concentric arrangements of electromagnets. The center-to-center spacing between electromagnets is determined in large part by the application, e.g. the nature of the assembly to be sealed and the holding power required. For example, larger substrates may require closer spacing. Illustratively, a center-to-center spacing between electromagnets on the order of 2.5 to 5 cm has been found useful for sealing multiple small OLED displays, on the order of 3 cm to 6 cm across, arranged on larger substrate sheets. Such applications will be described in greater detail below. However, a center-to-center spacing more than or less than this may be used when warranted.

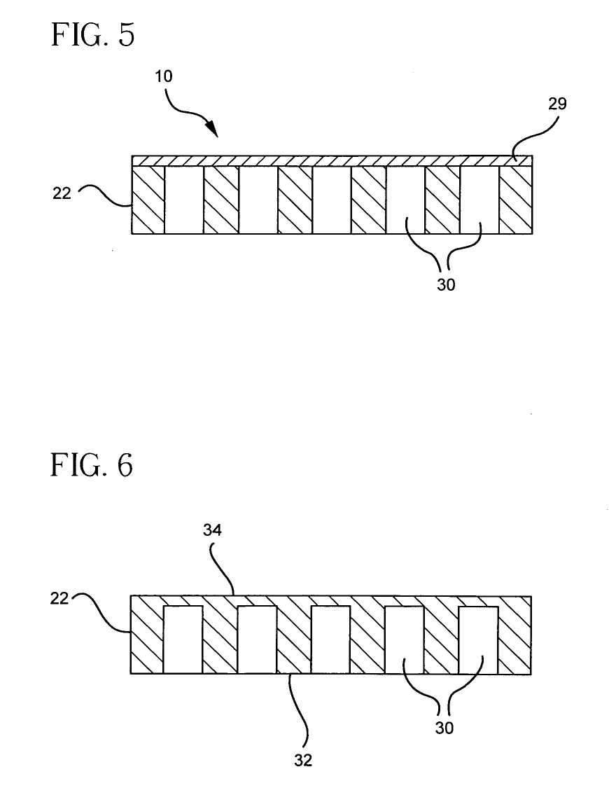

Support plate 22 may, for example, define a plurality of through holes 28, best seen in FIG. 4, into which the plurality of electromagnets are inserted. Each individual electromagnet 26 may be disposed in its corresponding through hole 28 such that the top of the electromagnet is flush with the top surface of support plate 22, thus allowing assembly 10 to be fully supported. Alternatively, a thin sheet of non-magnetic material 29 may be placed over support plate 22 between support plate 22 and display assembly 10, as shown in FIG. 5. This thin sheet of non-magnetic material may be affixed to support plate 22 or unfixed. In another embodiment shown in FIG. 6, bores 30 may be formed in a second surface 32 of support plate 22 opposite to the surface (first surface) 34 of the support plate that will be in contact with the assembly to be sealed (e.g. display assembly 10). The bores terminate below surface 34 of the support plate and therefore are not through holes. Electromagnets placed into the holes are thus maintained below surface 34 of the support plate.

Support plate 22 is preferably comprised of non-ferrous materials with a low specific heat, illustratively less than 1 Joule/(gram-deg C.). Suitable materials for support plate 22 include, but are not limited to aluminum, copper or brass. Alternatively, support plate 22 may be a ceramic material, or any other non-magnetic material capable of providing a firm, flat support surface for the sealing of display assembly 10. As used herein, a magnetic material is a material that is affected by a magnetic field, generally, but not exclusively, a ferrous material.

Electromagnets 26 are preferably in electrical communication with controller 40 and power supply 42 through electrical control line 44. It should be understood that electrical control line 44 may comprise a plurality of electrical lines such that the plurality of electromagnets may be controlled individually if desired, e.g. via controller 40. Each electromagnet is activated by flowing an electric current through the electromagnet. Controller 40 may comprise a computer, or other computing component (e.g. microprocessor) to enable programmed control of the electromagnets. For example, the current flowing in one electromagnet may be controlled to be different than the current flowing through another electromagnet. For substantially identical electromagnets, this equates to a different magnetic force being applied to an area of pressure plate 24 by the first electromagnet compared to the magnetic force generated by the second electromagnet. Moreover, the plurality of electromagnets may be divided into regions, wherein a first region made up of a first subset of electromagnets is controlled to produce a magnetic field different in magnitude than a second region made up of a second subset of electromagnets.

Individual electromagnets, or regions of electromagnets, may be controlled dynamically, wherein the current flowing through the electromagnets is adjusted in real time in response to the sealing process. By way of example, in the case of a pair of substrates comprising a plurality of displays, the electromagnets associated with the edge portions of the substrates might be controlled to generate a magnetic force different than the electromagnets associated with the inner portion of the substrates, e.g. stronger at the edge portions than at the inner portion. Depending on the order in which the frit seal was formed for the various displays, the magnetic force generated be the two regions might be varied during the process such that as the sealing of each display progressed, the relative magnetic forces changed, leading to a weaker magnetic force at the edge portions than at the inner portion. It should be understood that this is only an exemplary use of the embodiment, as other schemes may be used depending on the nature of the sealing process (e.g. sealing material, number of displays, substrate size, etc.).

Because prolonged activation of the electromagnets may generate undesirable heat in the support plate which can be transmitted to sensitive components of the substrate assembly, e.g. the organic materials of an organic light emitting diode, support plate 22 may further comprise passages 46 for circulating a cooling fluid through the interior of the support plate. Cooling may be necessary if the electromagnets are activated for extended periods of time. The cooling fluid may be water for example. The cooling fluid is preferably cooled by a refrigeration unit (not shown). Alternatively, support plate 22 may be cooled by flowing the cooling fluid over at least a portion of the exterior of the support plate. For example, the support plate may include heat dissipation fins, wherein air may be forced over the fin surfaces to cool the support plate. The heat dissipation fins are preferably located on a side of the support plate opposite display assembly 10, thereby maintaining a smooth support surface for the assembly to be sealed.

Pressure plate 24 comprises a magnetic material that is attracted by the magnetic force developed by electromagnets 26 when a current is flowed through the electromagnets by controller 40 and power supply 42. In an exemplary embodiment, pressure plate 24 may be formed from a magnetic stainless steel. For example, 440 grade stainless steel has been shown to be a suitable choice of material for pressure plate 24. Stainless steel has the advantage of resisting corrosion, and thus eliminating potentially contaminating corrosion by-products, and making the pressure plate easy to maintain. However, any magnetic material which exhibits suitable attraction to a magnetic field may be substituted if suitable cleanliness can be maintained.

In some embodiments, pressure plate 24 may be undersized relative to the pattern of frit. That is, when the pressure plate is positioned over the OLED assembly, the outer perimeter of the pressure plate does not extend past the inner perimeter of sealing material 20. When the electromagnets are activated, the pressure plate is drawn toward the electromagnets and a force is applied to the portion of the substrate over the OLED device. This configuration may, however, cause an inward curvature of a glass substrate over the OLED device that results in damaging contact between the substrate and the device. In a more preferred embodiment, the outer perimeter of pressure plate 24 extends beyond the perimeter of the sealing material (the pressure plate is larger than the area circumscribed by the sealing material), but defines one or more cutouts or apertures 48, as best seen in FIG. 3. Apertures 48 are sized such that when pressure plate 24 is properly positioned over display assembly 10, the outer-most perimeter of each pattern of sealing material 20 is internal to the inner-most boundary of a pressure plate aperture 48. More simply put, each aperture 48 is sized larger than the corresponding frame-shaped sealing material 20 such that when pressure plate 24 is positioned over assembly 10, access to the sealing material can be gained by sealing laser 21 positioned over assembly 10 and sealing material (e.g. frit) 20.

In addition to providing access to the frit by sealing laser 21, the oversized relationship of each aperture 48 relative to the corresponding sealing material 20 can provide a torque to the outside edges of the glass substrate 16 when electromagnets 26 are activated, thus causing a upward bow in glass substrate 16 over the OLED device. This upward bow prevents potentially damaging contact between glass substrate 16 and organic light emitting diode 12 during the sealing process.

To minimize damage to display assembly 10 by contact between pressure plate 24 and a glass substrate of the assembly, pressure plate 24 may be coated with a suitable coating that is softer than the glass substrate.

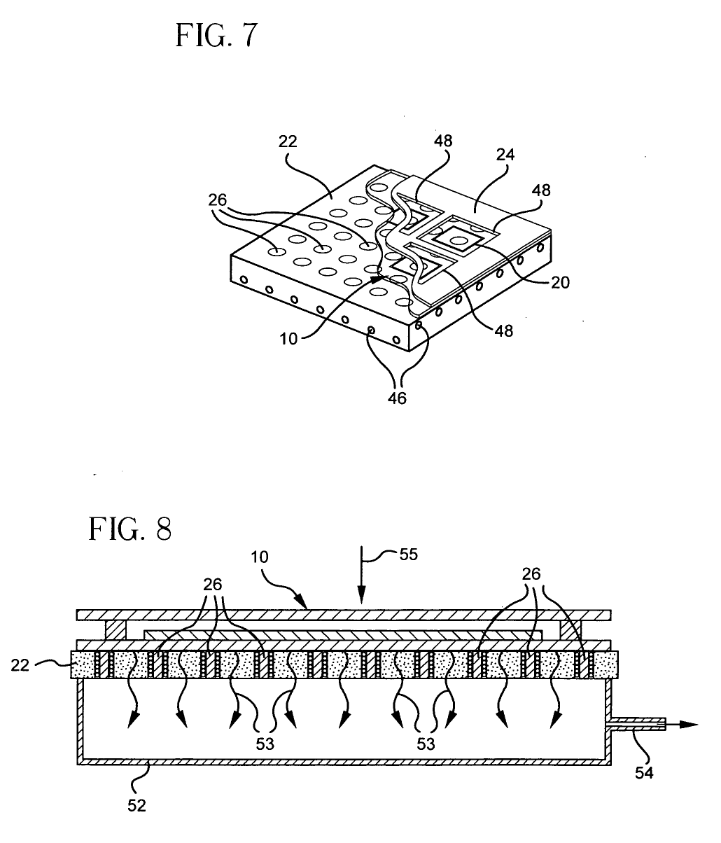

In another embodiment, a plurality of organic light emitting displays may be positioned between first and second glass substrates 14, 16, each of the OLED devices (or plurality of OLED devices) encircled by sealing material 20 to form individual displays. In such an embodiment, pressure plate 24 would define a plurality of apertures 48, each of the plurality of apertures positioned and sized to coincide with the sealing material in the manner described above. A cutaway of such an implementation is shown in FIG. 7. That is, each aperture 48 would be oversized with respect to a corresponding sealing material pattern, and positioned such that when the electromagnets are activated, a force will be applied outside the perimeter of the respective sealing material pattern.

In some embodiments, pressure plate 24 may be a continuous sheet of magnetic material—that is, without apertures. This may be advantageous if the method of sealing the substrates does not involve the necessity of irradiating the sealing material with electromagnetic radiation. For example, if substrates 14, 16 are to be sealed in a manner such that direct access to the sealing material through one or both of the substrates is not required, apertures in pressure plate 24 may be avoided.

In certain other embodiments, support plate 22 may be porous to allow a vacuum to be applied to the underside of the support plate (that side of the support plate opposite display assembly 10) that would augment the holding force exerted on assembly 10 by pressure plate 24. For example, shown in FIG. 8 is an illustration of an embodiment of a porous support plate 22, positioned over vacuum chamber 52. Vacuum chamber 52 can be evacuated by a suitable vacuum pump (not shown) connected with vacuum chamber 52 via vacuum line 54. The vacuum created within vacuum chamber 52 would be applied to the underside of a display assembly 10 through porous support plate 22, as represented by wavy lines 53, thereby holding display assembly 10 by virtue of the ambient pressure above the assembly (represented by arrow 55), and the reduced pressure below the assembly.

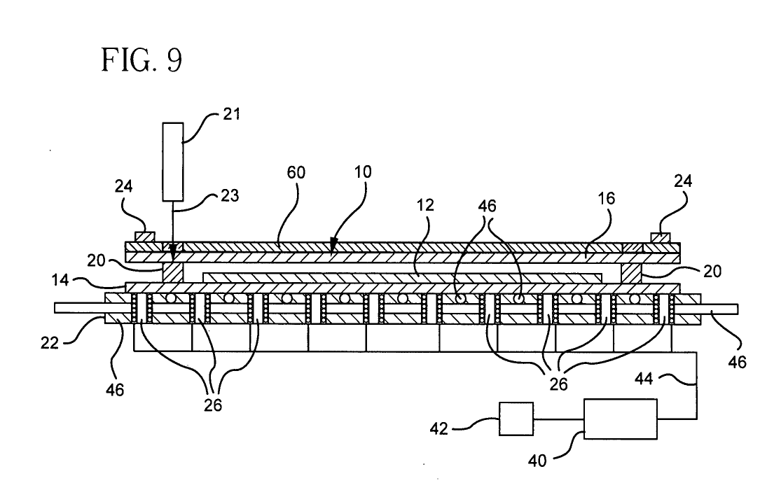

In some embodiments, a mask may be used to protect sensitive areas of a display assembly from overheating. For example, as described earlier, the use of a mask may be desirable if a broadband source such as an infrared lamp is the irradiating source. The mask blocks selected regions of the assembly, while allowing light to pass through to the assembly in other regions. In another illustrative use, a mask may be employed if the spot size of a laser used to irradiate the sealing material is larger than the width of the line of sealing material. FIG. 9 is similar to FIG. 2, except that a mask 60 has been inserted between display assembly 10 and pressure plate 24.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed is:

1. A method of sealing an electronic device comprising:
providing an assembly comprising first and second glass substrates in an opposed relationship, a frit positioned between the first or second substrates, and an electrical element positioned between the first and second substrates and encircled by the frit;
positioning the assembly on a support plate, the support plate comprising a plurality of electromagnets;
positioning a ferrous plate over the assembly;
flowing a current through the plurality of electromagnets thereby causing the ferrous plate to apply a force against the assembly; and
irradiating the frit with an irradiation source to heat and soften the frit and produce a hermetic seal between the first and second glass substrates and form the electronic device.

2. The method according to claim 1 wherein the electronic device is a display or a photovoltaic device.

3. The method according to claim 1 wherein the ferrous plate comprises an aperture that encircles the frit.

4. The method according to claim 2 wherein the assembly comprises a plurality of organic light emitting layers and the ferrous plate comprises a plurality of apertures

5. The method according to claim 1 wherein the assembly further comprises a sealing mask between the assembly and the ferrous plate.

6. The method according to claim 1 wherein the irradiation source is a laser.

7. The method according to claim 1 wherein the current flowing through a first electromagnet of the plurality of electromagnets is different than the current flowing through a second electromagnet of the plurality of electromagnets.

8. The method according to claim 1 wherein a force applied by a first portion of the ferrous plate is different than a force applied by a second portion of the ferrous plate.

9. The method according to claim 1 further comprising applying a vacuum to one of the glass substrates through the support plate.

10. The method according to claim 1 further comprising cooling the support plate with a cooling fluid.

11. The method according to claim 1 wherein the force is varied during the irradiating.

12. A method of sealing an electronic device comprising:
providing an assembly comprising first and second glass substrates in an opposed relationship, a frit disposed on one of the first or second substrates, and an electrically active layer encircled by the frit positioned between the first and second glass substrates;
positioning the assembly on a support plate comprising an array of electromagnets;
positioning a plate comprising a magnetic material over the assembly;
flowing a current through the plurality of electromagnets thereby causing the plate comprising the magnetic material to apply a force against the assembly;
irradiating the frit with a laser to heat and soften the frit and form a hermetic seal between the first and second glass substrates to form the electronic device.

13. The method according to claim 12 wherein a mask is positioned between the assembly and the plate comprising the magnetic material.

14. The method according to claim 12 wherein the frit is irradiated through a cutout in the plate comprising the magnetic material.

15. The method according to claim 12 further comprising varying the force during the irradiating.

16. The method according to claim 15 wherein varying the force comprises varying a current supplied to at least one of the plurality of electromagnets.

17. The method according to claim 12 further comprising positioning a mask between the assembly and the ferrous plate.

18. The method according to claim 12 further comprising applying a vacuum to the assembly through the support plate.

19. The method according to claim 12 wherein the electrically active layer comprises an photo-organic material.

20. The method according to claim 12 wherein the electrically active layer comprises a photovoltaic material.
